(19) United States
(12) Patent Application Publication
(10) Pub. No.: US 2026/0203863 A1
(43) Pub. Date: Jul. 16, 2026

(54) METHODS FOR TRANSILLUMINATING A LIGHT SCATTERING CARRIER OF INFORMATION AND PROCESSING OF THIS INFORMATION

(71) Applicant: FELIXSONIP B.V., NOOTDORP (NL)

(72) Inventor: Ronald Jan GELUK, NOOTDORP (NL)

(21) Appl. No.: 19/133,691

(22) PCT Filed: Nov. 30, 2023
(86) PCT No.: PCT/NL2023/050626

§ 371 Date: May 28, 2025

(30) Foreign Application Priority Data
Dec. 1, 2022 (NL) 1044480

(51) Int. Cl. G06T 5/50; G06T 5/70; G06T 5/75; G06T 7/586

(52) U.S. Cl. CPC G06T 5/50; G06T 5/70; G06T 5/75; G06T 7/586; G06T 2207/10056; G06T 2207/10152; G06T 2207/20212

(57) ABSTRACT

Photographic film or microscopic objects are transilluminated with a rotating angular light flux of a high aperture ratio. This enables retrieving information with a higher spatial bandwidth than heretofore possible. Furthermore, this way of transilluminating reduces, both, image noise and aliasing at the sensor array. The fundamentally different way of extracting information provides an improved basis for digital restoration of photographic material.
In microscopic applications scattering or fluorescent details can be better separated from transmitted image content.

### BACKGROUND OF THE INVENTION

Retrieving image information from light scattering objects like photographic films is limited by conflicting phenomena.

Firstly, scattering of light in the object causes point spreading which reduces spatial bandwidth. Reducing the relative amount of scattered light is possible by transilluminating with a small solid angular range, which, consequently, improves the spatial bandwidth up to the point that diffraction of light becomes the limiting factor. Due to these opposing effects of scattering versus diffraction, the spatial bandwidth cannot be larger than where the point spreading by scattering, equals the airy disc of diffraction.

For example, a photographic emulsion of 10 micron thickness and equal point spreading, corresponds to an airy disc diameter of an F/8 lens which, for that emulsion, limits the maximum bandwidth to about 50 Ip/mm at this lens aperture.

Secondly, probing object transmission over a small solid angular range lacks angular averaging and, therefore, comes with strong image noise.

### PRIOR ART

Known are film scanners that have diffuse illumination of the object for maximum angular averaging and, thus, minimizing image noise. This comes, however, with decreased sharpness. Also known are film scanners with a selectable ratio of specular and diffuse illumination for balancing between image sharpness and image noise. Also known is digital image processing for improving visual appearance. None of these methods improves the, more fundamental, extraction of information from film emulsions.

Extension of spatial bandwidth beyond the diffraction limit of a microscope has been demonstrated by illuminating with structured light. This method, however, reverses the spatial frequency spectrum and requires complex digital correction. Furthermore, this method applies, in practice, laser light and therefore, has poor angular averaging.

### DESCRIPTION

The present invention enables improved extraction of information from spatially absorbing patterns embedded in a light scattering carrier of information like a photographic emulsion. In this context also referred to as: “object”. The method involves transilluminating with at least one two-dimensional angular light flux, limiting this light flux in one dimension, rotating the dimensionally limited light flux over an axis that is in the direction of the imaging path and increasing the flux-density of the dimensionally limited light flux proportionally to the distance from the axis of rotation and/or shifting the axis of rotation over a plurality of positions.

### FIGURES

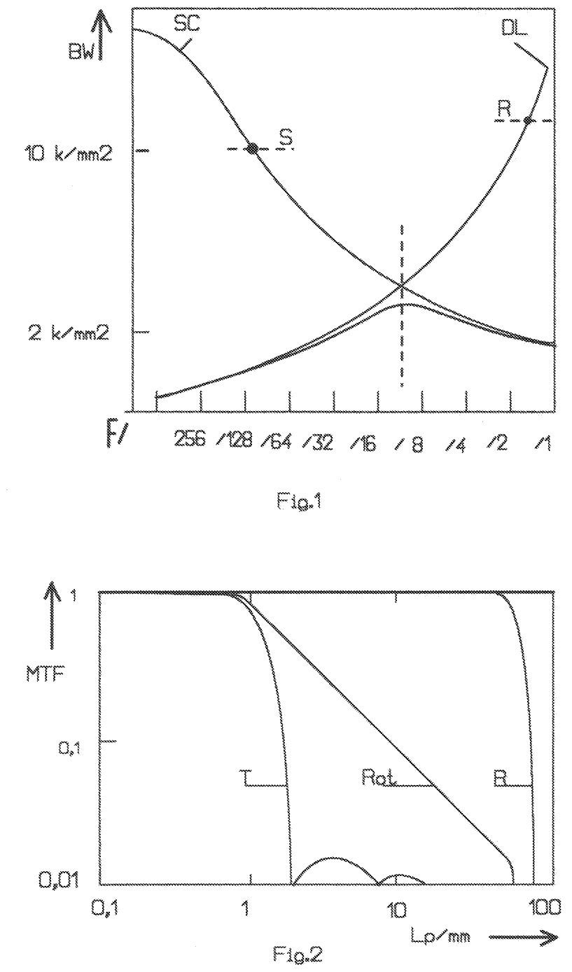

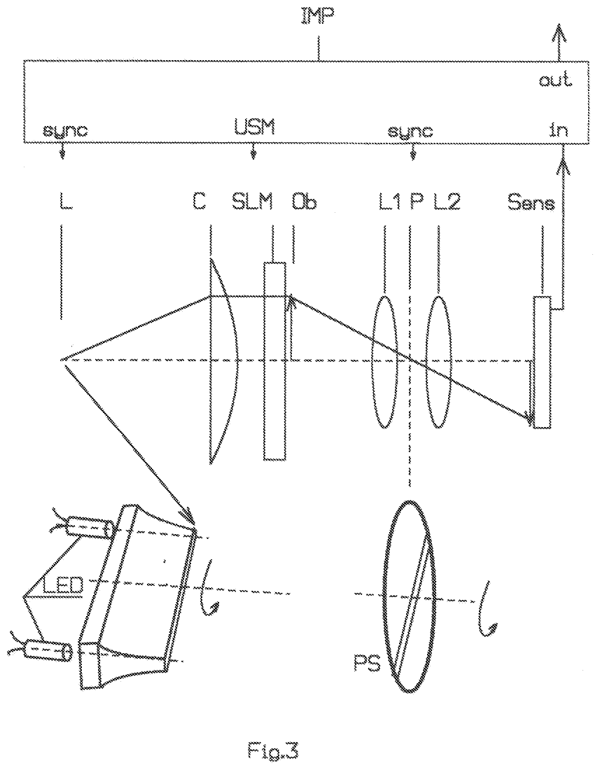

The invention is described in more detail with the aid of the figures in which: FIG. 1 shows curves of spatial bandwidth versus angular range in F numbers. FIG. 2 shows Modulation Transfer Functions (MTF) relating to different modes of transilluminating. FIG. 3 shows an imaging system for practicing methods according to the invention.

The following abbreviations have been applied here:
BW spatial bandwidth
SC spatial bandwidth of scattering object
DL diffraction limitation
MTF modulation transfer function
T tangential
Rot rotational
R radial
IMP image processor
Sync synchronization signal
USM unsharp mask
L light source
C condenser lens
SLM spatial light modulator
Ob object
L1 lens of lens pair
P pupil of lens pair
L2 lens of lens pair
Sens image sensor
LED light emitting diode
PS pupil scanner

### DETAILED DESCRIPTION

In FIG. 1, curve “SC” represents spatial bandwidth of an object versus the solid angular range of transillumination. The downhill shape of “SC” is caused by increased scattering as the solid angle of transilluminating increases.

Curve “DL” represents spatial bandwidth limitation by diffraction, which has an uphill shape. Considering both effects of scattering and diffraction, spatial bandwidth of the imaging process can be no larger than where curves “SC” and “DL” cross.

By limiting the light flux according to the invention, the object is imaged with a large spatial bandwidth in one direction only. In FIG. 1 this large bandwidth is indicated by point: “R” on curve “DL”. By rotating said light flux, the large spatial bandwidth applies, successively, to all other directions, thereby, enabling recording of the full spatial spectrum of the object in all directions.

As, the light scattering object is, yet, transilluminated with a light flux of a small solid angular range, its spatial bandwidth is large as indicated by point: “S” on curve “SC”. Correspondingly, an overall spatial bandwidth as high as indicated by “S” or “R” (whichever is lowest) can be obtained.

Integrating images of the object, as described, cause a rotational symmetric and gradually decreasing spatial response as indicated by MTF curve: “Rot” in FIG. 2. FIG. 2 also shows MTF curve “T” for the narrow dimension and MTF curve “R” for the wide dimension of the transilluminating light flux when not rotating.

Ultimately, MTF curve “Rot” rolls off more steeply because of diffraction, lens aberrations or scattering in the object.

Furthermore, the method comprises intensifying or widening of the light flux with increasing distance from the axis of rotation or, alternatively shifting the axis of rotation over a range of positions parallel to itself. This equalizes contributions from all angles of transillumination, as is required for effective angular averaging.

Those skilled in the art will recognize that a decreasing modulation transfer like: “Rot” in FIG. 2 reduces aliasing effects when imaging on a sensor matrix.

A further method of the invention comprises projecting a negative version of a first image, that has been obtained according to the invention, as an unsharp mask on the object and producing a second image by transilluminating with the projecting light flux according to the invention.

Said method of unsharp masking corrects, at least partially, the gradually decreasing spatial response as indicated by MTF curve “Rot” in FIG. 2 It also decreases the intensity signal range on the image sensor, thereby enabling reduction of sensor and photon noise.

Although transilluminating, according to the invention, extracts more information from the object than so far possible, it does require image enhancement to obtain images with a flat MTF. Therefore, the method also comprises storing and/or integrating images in an imaging system, and inverting the spatial response that results from transilluminating according to the invention.

Correcting spatial response, as required, increases signal gain towards higher spatial frequencies. As the extra gain also applies to sensor and photon noise, methods like multiple integrations, exposures at different light levels or unsharp masking may be considered.

FIG. 3 shows, schematically, and by way of example, an embodiment that enables practicing multiple methods according to the invention. In the direction of the light path, it contains the following elements:
1 Light source “L” that limits the light flux in one dimension and illuminates the object. Here, it contains two LED's that illuminate a distributor that increases its aspect ratio. The combination is mounted on an axis meant for rotation which, here, coincides with the optical axis of an imaging system. The light distributor is designed to provide uniform contributions of light from all angles when rotating. To this end, the light source can also be shaped like an elongated “bow tie”, a sharp triangle or the like.
2 Condenser “C”, as part of a Köhler illuminator.
3 Optional Spatial Light Modulator “SLM”.
4 Object “Ob” that contains the information to be retrieved. For simplicity, “SLM” is shown in contact with the object. Alternatively, a video projector or the like, can be laid out to have the function of, both, light source and spatial light modulator.
5 Lens pair “L1” and “L2” with pupil plane “P” wherein the light source is imaged.
6 Pupil scanner “PS” meant for rotating and limiting a light flux that leaves the object.
7 Area-sensor “S” meant for producing image signals.
8 Image processor “IMP” meant for calculating a negative version of the image and/or correcting the spatial response that results from transilluminating according to the invention.

The system of FIG. 3 can be laid out to three modes of transillumination:
(1) Exclusively limiting the transilluminating light flux that illuminates the object;
(2) Exclusively limiting the transilluminating light flux that leaves the object;
(3) Limiting the transilluminating light flux, both, on entering and on leaving the object.

In mode (1), the invention has only effect on transmitted light and not on omnidirectionally scattered or fluorescent light. In microscopy this improves discriminating scattering or fluorescent details versus transmissive image content. In mode (3), synchronously rotating “L” and coinciding diaphragm aperture “PS” enables collimated imaging of the object for further manipulating scattered light contributions.

Each of modes (1) to (3) can be combined with unsharp masking by activation of spatial light modulator “SLM”. The system as shown can operate in all 6 combinations of mode (1) to (3). Leaving out components like “PS” or “SLM” decreases the number of modes that are, yet, according to the invention.

1. Method for transilluminating and extraction and imaging of information from spatially absorbing patterns embedded in a light scattering carrier of information like a photographic emulsion, comprising illuminating with at least one two-dimensional angular light flux, of which one dimension is substantially larger than the other, characterized by
rotating said light flux over an axis which is in the direction of the imaging path; and integrating images that result thereof.

2. Method according to claim 1, characterized by increasing the light flux proportionally to the distance from the axis of rotation.

3. Method according to claim 1, characterized by producing two or more different images, and combining these different images in an image processor, wherein the different images result from different scatter ratios of transmitted light.

4. Method according to claim 1, characterized by restorating or displaying images that they have been obtained.
